(19) United States
(12) Patent Application Publication
(10) Pub. No.: US 2006/0212450 A1
(43) Pub. Date: Sep. 21, 2006

(54) Temporary master thread

(75) Inventor: Robert H. Earhart, Snohomish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/084,399

(22) Filed: Mar. 18, 2005

(51) Int. Cl. G06F 17/30

(52) U.S. Cl. 707/8

(57) ABSTRACT

The invention provides a temporary master thread mechanism that allows any thread wishing to update a data structure to become the temporary master thread for the data structure. A thread becomes a temporary master thread for the data structure by acquiring a lock associated with the data structure. A temporary master thread is capable of processing all pending updates for the data structure, wherein the pending updates can be introduced by the temporary master thread and/or other threads. The temporary master thread releases the lock after processing the pending updates for the data structure.

### FIELD OF THE INVENTION

This invention relates generally to computer software and, more particularly, to multi-threaded computing environments.

### BACKGROUND OF THE INVENTION

Traditionally, computer programs operate in single-threaded computing environments. A single-threaded computing environment means that only one task can operate within the computing environment at a time. A single-threaded computing environment constrains both users and computer programs. For example, in a single-threaded computing environment, a user is able to run only one computer program at a time. Similarly, in a single-threaded computing environment, a computer program is able to run only one task at a time.

To overcome the limitations of single-threaded computing environments, multi-threaded computing environments have been developed. In a multi-threaded computing environment, a user typically is able to run more than one computer program at a time. For example, a user can simultaneously run both a word processing program and a spreadsheet program. Similarly, in a multi-threaded computing environment, a computer program is usually able to run multiple threads or tasks concurrently. For example, a spreadsheet program can calculate a complex formula that may take minutes to complete while concurrently permitting a user to still continue editing a spreadsheet.

A problem arises, however, when two threads, of either the same or different computer programs, attempt to access concurrently the same data object or data structure that contains one or more data objects (hereinafter “data structure” will be used to refer to either a data object or a data structure). When exclusive access to the data structure is required by one or both of these threads, such concurrent access of the same data structure may result in corruption of the data structure, ultimately causing the computer hosting the data structure to crash. Therefore, when accessing a data structure, a thread generally is provided a lock associated with the data structure. Utilizing a lock ensures that other threads can only acquire limited rights to the data structure until the thread owning the lock is finished with using the data structure.

Multiple threads may access a data structure to update the data structure with specific modifications. Conventionally, the maintenance of a data structure that can be updated by multiple threads generally employs two approaches: A dedicated processing thread approach and a blocking lock acquisition approach. The dedicated processing thread approach lets a single thread have sole access to the shared data structure. This single thread is also called the master thread. Other threads communicate with the master thread through, for example, message passing, about desired updates to the shared data structure. Because the master thread can only do one thing at a time, concurrent access to the shared data structure is limited; but the integrity of the data structure is maintained. On the other hand, maintaining a dedicated processing thread approach requires additional system resources such as run-time memory and registers. The use of a dedicated processing thread also requires costly context switches. In particular, a computing environment may discourage the existence of threads that are not absolutely necessary. In such a computing environment, the creation and use of an additional thread as a dedicated processing thread to process updates by multiple threads on a shared data structure is considered a poor practice.

The blocking lock acquisition approach utilizes the lock associated with a data structure. A thread wishing to update the data structure can acquire the lock and update the data structure with modifications provided specifically by the thread. Upon completing the updating, the thread releases the lock so another thread can acquire the lock and update the data structure with modifications specifically provided by the another thread. The blocking lock acquisition approach serializes multiple threads' access to a data structure, thus impairing a computing system's scalability and performance. For example, when there are multiple threads wanting to update a data structure, a backlog can be induced. The backlog consists of threads waiting on the lock to be released before they can acquire the lock and modify the data structure. These threads cannot do anything else until they have updated the data structure. Such a backlog thus results in poor system performance.

As a result, the conventional approaches limit the performance, scalability, and resource usage of a computing system. Therefore, there exists a need of an approach that solves the shortcomings and disadvantages of the conventional approaches in updating a data structure that is shared by multiple threads. More specifically, there exists a need of an approach that creates no extra threads dedicated to process updates for a data structure. There also exists a need that allows multiple threads to compete for the lock associated with the data structure, yet induces no backlog of threads wanting to update the data structure.

### SUMMARY OF THE INVENTION

This invention addresses the above-identified needs by providing an update mechanism that enables any thread attempting to update a data structure to become a temporary master thread. The temporary master thread processes updates for the data structure, wherein the updates are introduced by the temporary master thread itself and/or by other threads. The invention thus allows updates for a data structure to be processed without maintaining a dedicated processing thread, involving costly context switches, or inducing backlog of threads waiting to update the data structure.

In accordance with one aspect of the invention, a thread wanting to update a data structure (hereinafter “update thread”) becomes a temporary master thread for the data structure by acquiring a lock associated with the data structure. The temporary master thread can then process all pending updates for the data structure, wherein the pending updates are introduced by the temporary master thread itself or by other threads. Preferably, threads wanting to update the data structure write pending updates for the data structure to a shared memory. Thus, all pending updates for the data structure are visible to the threads. If one of the threads becomes a temporary master thread, the temporary master thread processes the pending updates for the data structure by reading from the shared memory.

In accordance with another aspect of the invention, the data structure is associated with an Updated flag, whose value indicates whether the data structure has any pending update. Once a thread writes any pending update to the shared memory, the thread also sets the Updated flag. Once the thread successfully acquires the lock associated with the data structure and has become the temporary master thread, it clears the Updated flag and proceeds to process all pending updates for the data structure.

In accordance with another aspect of the invention, once the temporary master thread finishes processing all pending updates for the data structure, the temporary master thread releases the lock and therefore relinquishes its role of being the temporary master thread. Preferably, upon releasing the lock, the thread checks the value of the Updated flag to see if there are any additional pending updates accumulated during the thread's processing of pending updates that previously existed in the shared memory. If there are additional pending updates, the thread may try to acquire the lock again. If the thread successfully acquires the lock again, it becomes the temporary master thread again. If not, this means that another thread wanting to update the data structure has already acquired the lock and becomes the temporary master thread.

The temporary master thread mechanism is used where multiple threads may want to update a data structure in a concurrent (typically interlocked) fashion, where some amount of processing needs to be performed in a serialized fashion, and where it does not matter exactly which thread performs the processing. The invention improves system performance by eliminating the need to maintain a dedicated processing thread and by allowing the updates to be processed without costly context switches. The invention thus improves the performance and scalability of a computing environment.

The invention includes systems, methods, and computers of varying scope. Besides the embodiments, advantages and aspects of the invention described here, the invention also includes other embodiments, advantages and aspects, as will become apparent by reading and studying the drawings and the following description.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating the hardware and operating environment in which embodiments of the invention may be practiced;

FIG. 2 is a block diagram illustrating a system according to an exemplary embodiment of the invention; and

FIGS. 3-5 are flow diagrams illustrating an exemplary process according to the exemplary embodiment of the invention illustrated in FIG. 2.

### DETAILED DESCRIPTION OF THE PREFERRED EMBODIMENT

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

The detailed description is divided into four sections. In the first section, the hardware and the operating environment in conjunction with which embodiments of the invention may be practiced are described. In the second section, a system of one embodiment of the invention is presented. In the third section, a computerized process, in accordance with an embodiment of the invention, is provided. Finally, in the fourth section, a conclusion of the detailed description is provided.

I. Hardware and Operating Environment

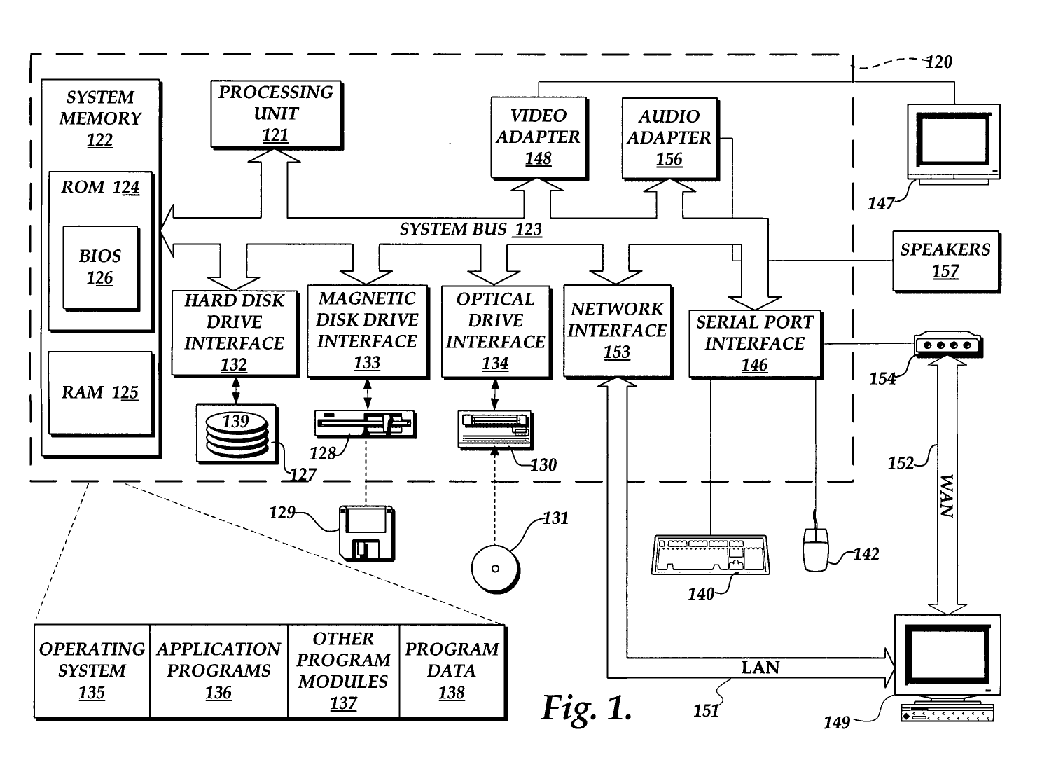

FIG. 1 and the following discussion are intended to provide a brief and general description of a suitable computing environment in a client device in which the invention may be implemented.

Although not required, the invention will be described in the context of computer-executable instructions, such as program modules, being executed by a personal computer. Generally, program modules include routines, programs, objects, components, data structures, etc. that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. As noted above, the invention may also be practiced in distributed computing environments where tasks are performed by remote processing devices that are linked through a communications network. In a distributed computing environment, program modules may be located in both local and remote memory storage devices. It should be further understood that the present invention may also be applied to much lower-end devices that may not have many of the components described in reference to FIG. 1 (e.g., hard disks, etc.).

With reference to FIG. 1, an exemplary system for implementing the invention includes a general purpose computing device in the form of a conventional personal computer 120. The personal computer 120 includes a processing unit 121, a system memory 122, and a system bus 123 that couples various system components including the system memory to the processing unit 121. The system bus 123 may be any of several types of bus structures, including a memory bus or memory controller, a peripheral bus, and a local bus using any of a variety of bus architectures. The system memory includes read only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 further includes a hard disk drive 127 for reading from and writing to a hard disk 139, a magnetic disk drive 128 for reading from or writing to a removable magnetic disk 129, and an optical disk drive 130 for reading from or writing to a removable optical disk 131, such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer-readable instructions, data structures, program modules, and other data for the personal computer 120.

Although the exemplary environment described herein employs a hard disk 139, a removable magnetic disk 129, and a removable optical disk 131, it should be appreciated by those skilled in the art that other types of computer-readable media that can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules may be stored on the hard disk 139, magnetic disk 129, optical disk 131, ROM 124, or RAM 125, including an operating system 135, one or more application programs 136, other program modules 137, and program data 138.

A user may enter commands and information into the personal computer 120 through input devices, such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus, but may be connected by other interfaces, such as a parallel port, game port, or a universal serial port (USB). A monitor 147 or other type of display device is also connected to the system bus 123 via an interface, such as a video adapter 148. In addition to the monitor, personal computers typically include other peripheral output devices (not shown), such as speakers and printers.

The personal computer 120 may operate in a networked environment using logical connections to one or more remote computers, such as a remote computer 149. The remote computer 149 may be another personal computer, a server, a router, a network PC, a peer device, or other common network node, and typically includes many or all of the elements described above relative to the personal computer 120, although only a memory storage device has been illustrated in FIG. 1. The logical connections depicted in FIG. 1 include a local area network (LAN) 151 and a wide area network (WAN) 152. Such networking environments are commonplace in offices, enterprise-wide computer networks, Intranets, and the Internet.

When used in a LAN networking environment, the personal computer 120 is connected to the local network 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary, and other means of establishing a communications link between the computers may be used.

II. System

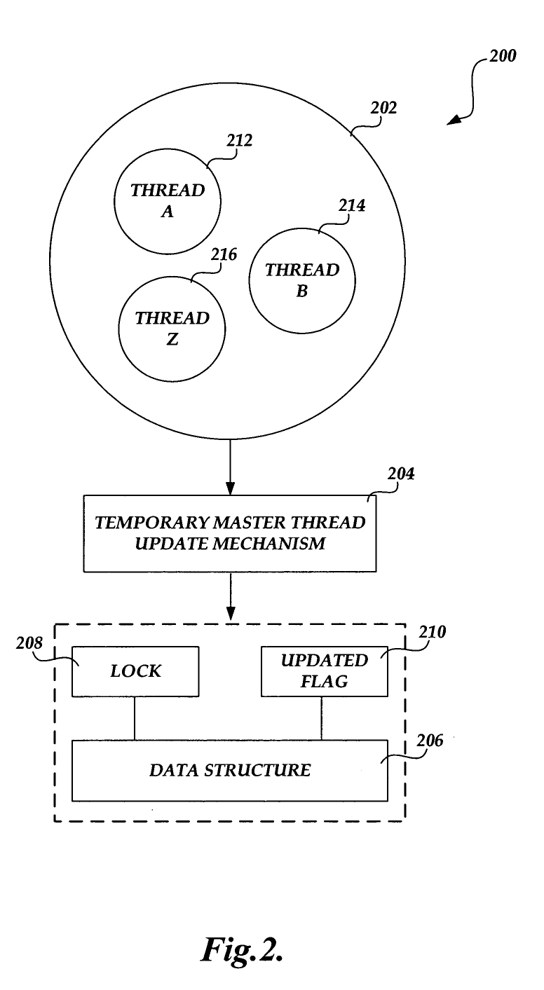

In this section of the detailed description, a description of a computerized system according to an embodiment of the invention is provided. The description is provided by reference to FIG. 2. Referring now to FIG. 2, a system 200 according to an embodiment of the invention is shown. The system 200 includes multiple threads 202, a temporary master thread update mechanism 204, and a data structure 206. The system 200 also includes a lock 208 and an Updated flag 210, both of which are associated with the data structure 206. For purposes of descriptive clarity, only one data structure 206 and the multiple threads 202 requesting to update the data structure 206 are shown. Those of ordinary skill within the art can appreciate, however, that the invention is not so numerically limited. Numerous data structures along with their associated locks, Updated flags, and corresponding sets of threads requesting to update the data structures may exist in the system 200.

In embodiments of the invention, the multiple theads 202 are the set of threads that request to operate on the data structure 206 in a multi-threaded computing environment. Each of the multiple threads 202, such as representative thread A 212, thread B 214, and thread Z 216, is an executable task that is capable of updating the data structure 206. As those of ordinary skill in the art will appreciate, the multiple threads 202 may not be exclusively associated with the data structure 206. For example, one or more of the multiple threads 202 may also request to update other data structures existing in the multi-threaded computing environment.

The data structure 206 contains data that the multiple threads 202 may wish to modify. One exemplary data structure 206 is a timer queue that contains one or more timers used by a computing system to measure time intervals. The multiple threads 202 may request to set or clear one or more timers in the timer queue, for example.

In embodiments of the invention, each data structure 206 is associated with a lock 208. As known by those of ordinary skill in the art, each lock, such as the lock 208, is a specific type of software object that is specifically utilized to lock a data structure, such as the data structure 206, to a thread, such as the thread A 212. The data structure 206 may be associated with a pointer. When the pointer points to the lock 208, the lock 208 is associated with the data structure 206.

The data structure 206 may also be associated with an Updated flag 210. The Updated flag 210 is used to indicate whether data in the data structure 206 needs to be modified. Any thread among the multiple threads 202 can access the Updated flag 210 and configure its value.

In some embodiments of the invention, the lock 208 may be implemented as a single bit and combined with the Updated flag 210. This implementation allows the lock 208 to be released and the Updated flag 210 to be tested as a single atomic operation.

In embodiments of the invention, the temporary master thread update mechanism 204 enables any one of the multiple threads 202, such as the thread A 212, to become a temporary master thread by acquiring the lock 208. If the thread A 212 succeeds in acquiring the lock 208, the thread A 212 becomes the temporary master thread for the data structure 206. The temporary master thread clears the Updated flag 210, processes pending updates on the data structure 206, and then releases the lock object 208. The temporary master thread then checks the value of the Updated flag 210 to determine whether additional pending updates have been accumulated during the temporary master thread's processing of updates for the data structure 206. If the answer is YES, the temporary master thread will try to re-acquire the lock 208 to process the additional pending updates. If the temporary master thread cannot re-acquire the lock 208, it means that another thread has acquired the lock 208 and thus becomes the new temporary master thread.

The temporary master thread update mechanism 204 is used when multiple threads can update the data structure 206 in a concurrent fashion. The temporary master thread update mechanism 204 can be used when it does not matter exactly which thread processes updates for the data structure 206. Therefore, if the thread A 212 acquires the lock 208, the thread A 212 will process pending updates for the data structure 206, wherein the pending updates can be introduced by the thread A 212 itself, or by other threads among the multiple threads 202.

In an exemplary embodiment of the invention, the system 200 may operate in the following exemplary fashion. Assuming the thread A 212 among the multiple threads 202 desires to update data in the data structure 206. The thread A 212 first writes its desired updates to a shared memory so the updates are visible to other threads among the multiple threads 202. This visibility ensures that other threads may process the updates if the thread A 212 fails to acquire the lock 208 associated with the data structure 206. The thread A 212 then sets the Updated flag 210 to indicate that data in the data structure 206 needs to be updated. The thread A 212 then attempts to become the temporary master thread by trying to acquire the lock 208. If the thread A 212 fails to acquire the lock 208, some other thread has taken the lock 208 and thus has become the temporary master thread, and may process the updates made by the thread A 212. On the other hand, if the thread A 212 succeeds in acquiring the lock 208, the thread A 212 becomes the temporary master thread for the data structure 206. The thread A 212 then clears the Updated flag 210, processes all pending updates for the data structure 206, and releases the lock 208. The thread A 212 may also retest the Updated flag 210 to see if additional updates for the data structure 206 have been provided by other threads just before the lock 208 is released.

III. Process

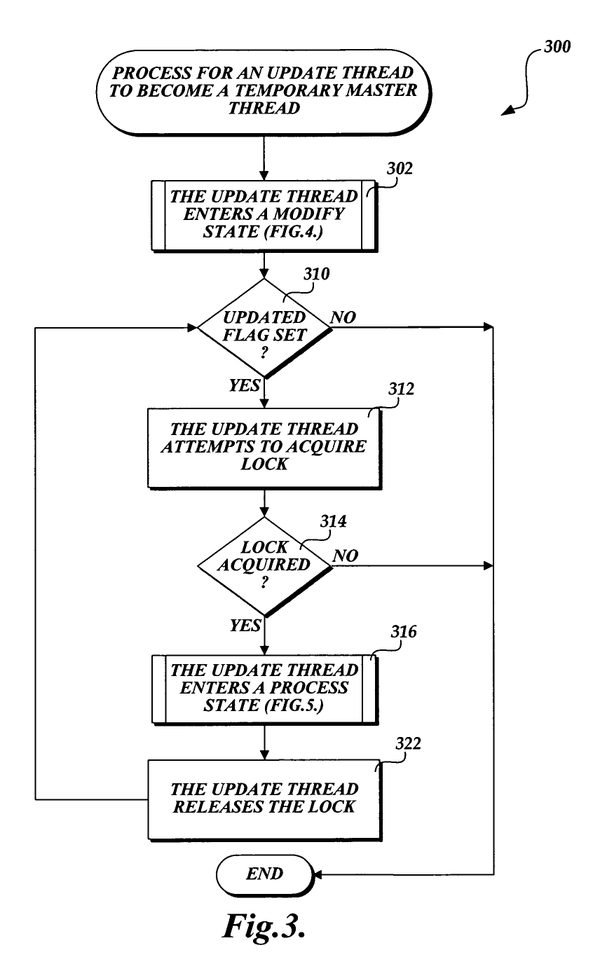

In this section of the detailed description, a computerized process according to an embodiment of the invention is presented. This description is provided in reference to FIGS. 3-5. The computerized process is desirably realized at least in part as one or more programs running on a computer—that is, as a program executed from a computer-readable medium such as a memory by a processor of a computer. The programs are desirably storable on a computer-readable medium such as a floppy disk or a CD-ROM, for distribution, installation, and execution on another (suitably equipped) computer. Thus, in one embodiment, a temporary master thread update mechanism is executed by the processor from the medium to enable a thread such as the thread A 212 to update data in a data structure such as the data structure 206. The computerized process can further be used in conjunction with the system 200 of FIG. 2, as will be apparent to those of ordinary skill within the art.

Referring now to FIG. 3, a flowchart of a process 300 according to one embodiment of the invention is shown. The process 300 is described with reference to the system 200 of FIG. 2. The process 300 illustrates how an update thread, such as the thread A 212, becomes a temporary master thread and updates data in a data structure such as the data structure 206.

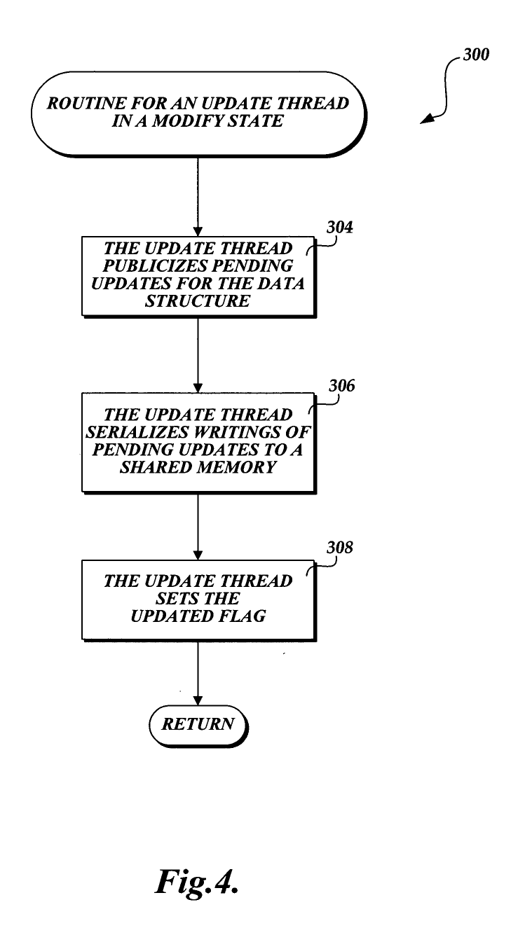

Specifically, the process 300 starts by executing a routine 302 in which the update thread enters into a modify state to provide updates for data in the data structure. FIG. 4 illustrates an exemplary implementation of the routine 302. As shown in FIG. 4, the routine 302 starts by the update thread publicizing updates for the data structure. See block 304. In embodiments of the invention, the update thread writes the pending updates to a shared memory so that the pending updates are visible to other threads. Such a shared memory can be a global memory that is accessible by other threads. In embodiments of the invention, the update thread serializes the writings of the pending updates to the shared memory. See block 306. In an exemplary embodiment of the invention, the serialization is achieved by the use of the WIN32 API MemoryBarrier( ). As known by those of ordinary skill in the art, the MemoryBarrier( ) function ensures that all memory load or store operations before the MemoryBarrier( ) function call complete before an unload or store operation following the MemoryBarrier( ) function call. The MemoryBarrier( ) function is called to serialize memory reads and writes that are critical for the operation of a computer program. The MemoryBarrier( ) function is often used with multi-thread synchronization functions such as interlocked exchange operations. The MemoryBarrier( ) function can be called on all processor platforms where Microsoft® Windows® operating system is supported. After serializing the writings of pending updates to a shared memory, the update thread sets the Updated flag associated with the data structure, such as the Updated flag 210 illustrated in FIG. 2. See block 308. The routine 302 then returns.

Returning to FIG. 3, after executing the routine 302, the process 300 proceeds to determine whether the Updated flag associated with the data structure that the update thread desires to modify is set. See decision block 310. If the answer to decision block 310 is NO, it means there are no pending updates to the data structure. The process 300 then ends, since there is no change needed to be made to the data structure. On the other hand, if the answer to the decision block 310 is YES, meaning there are pending updates for the data structure, the update thread attempts to acquire the lock associated with the data structure. See block 312. By acquiring the lock associated with the data structure, the update thread ensures that no other thread can concurrently update the data structure, thus ensuring the consistency of data in the data structure. The process 300 then proceeds to determine whether the update thread has acquired the lock associated with the data structure. See decision block 314. If the answer to decision block 314 is NO, meaning that the update thread fails to acquire the lock associated with the data structure, then another thread owns the lock, is the temporary master thread, and will process the pending updates provided by the update thread in the shared memory. The process 300 terminates. The update thread can proceed to other work, since the current temporary master thread will process only updates for the data structure introduced by the update thread. Thus, the invention avoids the formation of a backlog of threads waiting to update the data structure.

On the other hand, if the answer to the decision block 314 is YES, meaning that the update thread has acquired the lock associated with the data structure, the update thread thus becomes the temporary master thread for the data structure. The process 300 then enters into a routine 316 where the update thread enters into a process state to process any pending updates in the shared memory that are applicable to the data structure. As noted above, such pending updates could have been provided by the temporary master thread itself, or by any other thread that requests to update the data structure. That is, any thread among the multiple threads 202 illustrated in FIG. 2 can provide one or more of the pending updates.

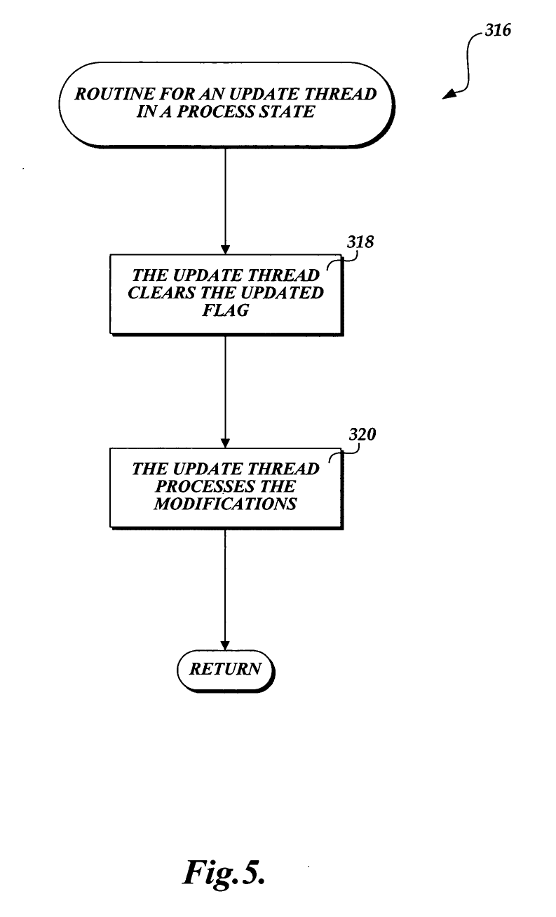

FIG. 5 illustrates an exemplary implementation of the routine 316. As shown in FIG. 5, the update thread first clears the Updated flag associated with the data structure. See block 318. The update thread then proceeds to process all existing pending updates for the data structure. See block 320. The routine 316 then returns. While the update thread processes existing pending updates for the data structure, other threads can continue to write additional pending updates for the data structure in the shared memory. In an exemplary embodiment of the invention, after issuing an instruction to clear the Updated flag, the update thread makes a MemoryBarrier( ) function call to ensure that the Updated flag is cleared before the execution of any memory read or write resulted from processing the pending updates.

Returning to FIG. 3, after executing the routine 316 where the update thread processes pending updates for the data structure, the update thread then proceeds to release the lock associated with the data structure. See block 322. As noted above, because the update thread clears the Updated flag associated with the data structure before the update thread processes pending existing updates, it is possible that other threads may have provided additional pending updates for the data structure and set the Updated flag. Therefore, the process 300 loops back to the decision block 310 to determine whether the Updated flag is set, i.e., whether additional pending updates for the data structure are available. If the answer is YES, the update thread will try to re-acquire the lock associated with the data structure and to process the additional pending updates. If the answer to decision block 310 is NO, then there are no additional pending updates, the process 300 terminates. The update thread thus has relinquished its role of a temporary master thread.

IV. Conclusion

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

The embodiments of the invention in which an exclusive property or privilege is claimed are defined as follows:

1. A system for enabling one of a plurality of threads to become a temporary master thread that is capable of processing one or more pending updates for a data structure, comprising:
a plurality of threads;
at least one data structure that the plurality of threads wants to update; and
an update mechanism for enabling one of the plurality of threads to become a temporary master thread that is capable of processing one or more pending updates for the data structure, wherein the one or more pending updates are introduced by any of the plurality of threads.

2. The system of claim 1, wherein the data structure is associated with a lock, and one of the plurality of threads becomes a temporary master thread by successfully acquiring the lock.

3. The system of claim 2, wherein the data structure is further associated with an Updated flag that indicates whether the data structure has any pending update.

4. The system of claim 3, wherein the lock and the Updated flag are operated as one atomic unit.

5. The system of claim 1, wherein one of the plurality of threads wanting to update the data structure writes one or more pending updates for the data structure to a shared memory so all pending updates for the data structure are visible to the plurality of threads.

6. The system of claim 5, wherein writings of the pending updates for the data structure to the shared memory are serialized.

7. The system of claim 2, wherein one of the plurality of threads wanting to update the data structure
attempts to acquire the lock associated with the data structure;
upon successfully acquiring the lock associated with the data structure, processes all pending updates for the data structure; and
releases the lock after processing all pending updates for the data structure.

8. The system of claim 7, wherein one of the plurality of threads wanting to update the data structure attempts to re-acquire the lock associated with the data structure after releasing the lock and finding one or more additional pending updates for the data structure.

9. A computer-implemented method for enabling one of a plurality of threads to become a temporary master thread that is capable of processing one or more pending updates for a data structure, comprising:
attempting to associate exclusively a lock of a data structure with one of a plurality of threads; and
enabling the thread to process all pending updates for the data structure if the attempt to associate exclusively the thread with the lock of the data structure is successful, wherein the pending updates are introduced by any of the plurality of threads.

10. The computer-implemented method of claim 9, further comprising writing pending updates for the data structure to a shared memory so all pending updates for the data structure are visible to the plurality of threads.

11. The computer-implemented method of claim 10, wherein writings of the pending updates for the data structure to the shared memory are serialized.

12. The computer-implemented method of claim 9, further comprising setting an Updated flag that is associated with the data structure to signal that there is at least one pending update for the data structure.

13. The computer-implemented method of claim 12, wherein enabling the thread to process all pending updates for the data structure includes clearing the Updated flag before the thread processes all pending updates for the data structure.

14. The computer-implemented method of claim 13, wherein the thread:
releases the lock after processing all pending updates for the data structure; and
attempts to re-acquire the lock if the Updated flag is set.

15. A computer system for enabling one of a plurality of threads to become a temporary master thread that is capable of processing one or more pending updates for a data structure, comprising:
(a) a memory; and
(b) a processor, coupled with the memory, for:
(i) attempting to associate exclusively a lock of a data structure with one of a plurality of threads; and
(ii) enabling the thread to process all pending updates for the data structure if the attempt to associate exclusively the thread with the lock of the data structure is successful, wherein the pending updates are introduced by any of the plurality of threads.

16. The computer system of claim 15, wherein the processor writes pending updates for the data structure to a portion of the memory that are shared by the plurality of threads so all pending updates for the data structure are visible to the plurality of threads.

17. The computer system of claim 16, wherein writings of the pending updates for the data structure to the portion of the memory are serialized.

18. The computer system of claim 15, wherein the processor sets an Updated flag associated with the data structure to signal that there is at least one pending update for the data structure.

19. The computer system of claim 18, wherein enabling the thread to process all pending updates for the data structure includes clearing the Updated flag before the thread processes all pending updates for the data structure.

20. The computer system of claim 19, wherein the thread:
releases the lock after processing all pending updates for the data structure; and
attempts to re-acquire the lock if the Updated flag is set.
